(19) United States
(12) Patent Application Publication
(10) Pub. No.: US 2004/0075839 A1
(43) Pub. Date: Apr. 22, 2004

(54) Novel high-precision lambdameter operating without optical moving parts

(76) Inventors: Yves Surrel, Etienne (FR); Patrick Juncar, Etiolles (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/274,686

(22) Filed: Oct. 21, 2002

(51) Int. Cl. G01B 9/02

(52) U.S. Cl. 356/450

(57) ABSTRACT

A system for measuring optical wavelengths of the kind sometimes referred to as a lambdameter. The invention applies to systems based on equipment of the interferometer type having an offset in time (FIG. 1) or in space (FIG. 4) enabling a reference optical wavelength to be compared with unknown optical wavelengths to be determined without any mechanical displacement of optical parts being needed during measurement. Original methods of calculation of the algorithmic type adapted to detecting phase associated with the least squares method are used for processing information. The measurement uncertainty of such a novel lambdameter is very small.

The present invention relates to novel types of wavelength-measuring instrument, in particular for measuring optical wavelengths, and sometimes referred to as “lambdameters”.

In the present state of the art, lambdameters are essentially constituted by a basic piece of equipment of the Michelson interferometer type, with the position of one of the mirrors being varied while the other remains fixed. Two beams are sent simultaneously into the interferometer, one representing a reference wavelength λᵣ and the other representing the unknown wavelength λᵢ to be determined. The total phase difference between the interference signals Δφ (λᵣ) and Δφ (λᵢ) is measured for each of the two beams and for two different positions of the moving mirror.

The ratio:

$$\frac{Δ φ ( {λ}_{r} )}{Δ φ ( {λ}_{i} )}$$

is equal to the ratio of the wavelengths λᵢ/λᵣ.

For an optimal precision of a measurement of the ratio

$$\frac{Δ φ ( {λ}_{r} )}{Δ φ ( {λ}_{i} )}$$

(and so of the ratio λᵢ/λᵣ), the preferred approach has been to measure Δφ (λᵣ) and Δφ (λᵢ) which should be as high as possible so as to ensuring a great precision of the ratio

$$\frac{Δ φ ( {λ}_{r} )}{Δ φ ( {λ}_{i} )}$$

Practically, the phase Φ is indicated by the intensity at a point which is illuminated by the interfering light.

In the prior art, the phase difference for the two positions of the mirror is furthermore determined through two steps.

The first consists in counting a number of intensity maxima which are overpassed during the displacement of the mirror. This counting indicates the integer part of the phase difference, which is for example 200 000, and which must be counted in a strictly exact manner.

The second step consists in measuring the fractionnary part of the phase difference through an as high as possible evaluation of the phase in the two mirror positions.

In other words, it is measured as precisely as possible the fractionary part of the phase difference (intensity light thanks to interference) and counted the number of sinusoids between the two intensities appearing intermediary during the displacement of the mirror. The more sinusoids are overpassed and the more it is ensured that the dividing and the divided parts are high in the ratio λᵢ/λᵣ (Δphiᵢ/Δphiᵣ) and the more the measurement is estimated as precise.

The inventors have identified that the ratio between the two phase differences could be interpreted as the slope of the straight line in a plan which illustrates the phase measure for the reference with lengths Φ (λr) as a function of the phase measure for the unknown wavelength Φ (λi).

Departing from this observation, and defining the aim of the measurement as determining the slope of a straight line given by two phase measurements on each of the wavelengths, the inventors propose to identify this slope through an approach which is different from the simple determining of two points chosen as far as possible. This new approach aims at providing a different method for determining λi with an increase precision.

For that purpose, it is here proposed an optical system and method according to claims 1 and 10.

The invention will be better understood from the following explanations and figures.

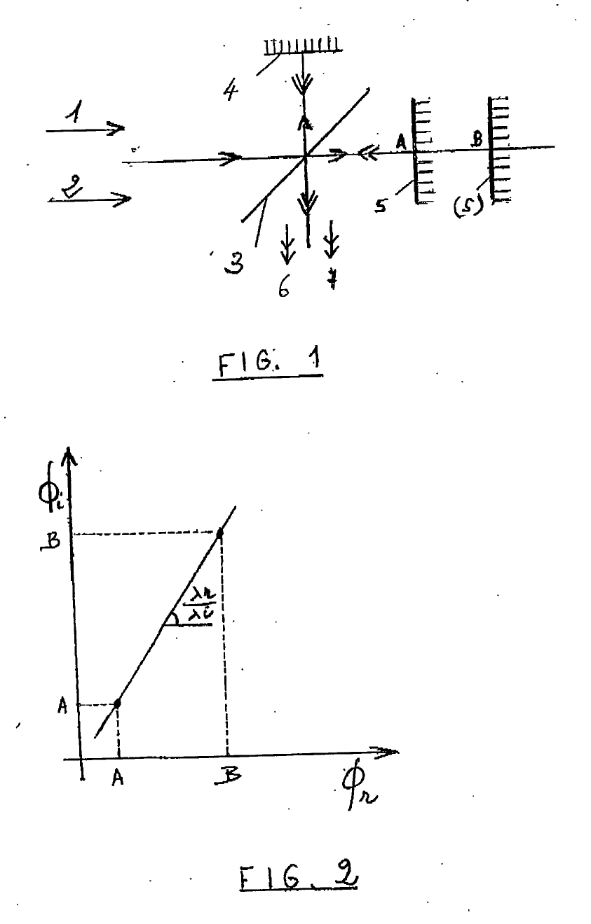

FIG. 1 is highly diagrammatic and recalls the structure of a conventional commercially-available lambdameter.

The directions 1 and 2 represent light rays, respectively at the reference wavelength λᵢ and at the unknown wavelength λᵢ that is to be determined. Using the operating principle of a Michelson interferometer and for both positions A and B of the mirror 5, the rays 1 and 2 pass through a semitransparent mirror 3 and are subjected to total reflection on mirrors 4 and 5 so as to present at outlets 6 and 7 of the interferometer a total phase difference of the interference fringes corresponding to the two rays 1 and 2 given by:

$$φ = \frac{4 π x}{λ} cos i$$

where:

x represents the distance between two different positions A and B for the mirror 5;

λ is the wavelength in the propagation medium (usually air); and

i is the inclination of the rays relative to the normal at the mirrors 4 and 5.

Piezoelectric spacers secured to the mirrors 5 serve to achieve as exact as possible a determination of the phases φᵢ and φᵣ in the initial and final states.

The unknown wavelength λᵢ is evaluated on the basis of the straight line shown in the graph of FIG. 2 and the slope λᵣ/λᵢ is equal to:

$$\frac{Δ {φ}_{i}}{Δ {φ}_{r}}$$

According to a first feature of the novel lambdameter of the invention, the phases φᵢ and φᵣ of the rays 1 and 2 from which the wavelength λᵢ to be found is derived directly are themselves obtained “continuously” throughout the displacement of the mirror 5.

Phase is measured by sampling temporarily the interference signals and by using an algorithm for setting up the phase quasi instantly through interpreting of the interference signal intensity during its evolution. Usable algorithms are those known as adapted to detecting a phase.

This preferred device works on the basis of an algorithm using for example five successive measurement of intensity for providing the phase known per se by the skilled person. This device provides a series of phases measurement illustrating the time evolution of the phase during the displacement of the mirror, i.e. a series of successive points of the straight line Δphiᵢ/Δphiᵣ which is to identify.

A theoretical study of such algorithms has previously been carried out by one of the inventors (Yves Surrel) in preliminary feasibility studies, published in the journal Applied Optics, Vol. 35, No. 1, pp. 51-60, 1996, under the title “Design of algorithms for phase measurements by the use of phase stepping”. The success of that theoretical feasibility study has made it possible to proceed with innovative experimental work, the results of which form part of the subject matter of the present patent application.

The algorithm adapted to detecting phase as best as possible presents the additional advantage of not requiring close synchronization between the sampling frequency and the corresponding interference signal frequency.

Unlike commercially-available lambdameters where a changing of phase for two positions is measured, determining phase “continuously” for determining a straight line in accordance with the preferred embodiment of the invention makes it possible to obtain a more precise result on the base of a large number of points. This makes it possible to use the “least squares method” to obtain the ratio λᵢ/λᵣ with very small uncertainty.

According to a second feature of the invention, path length variation in time is replaced by path length variation in space.

In other words, production of a high number of measure points for various lengths of progress is used by exploiting a spatial expression of the differences of the progress lengths, typically a series of interference fringes. These fringes are realised for example by introduction, in the flow of direct light, of two Young holes, or by using a Michelson specifically used in large beam (contrary to the known devices which are in fine beam).

On this spatial expression, it is realised localised measures each one corresponding spatially to a difference of respective progress length.

In other words, in this particular embodiment, different places are considered in a spatial expression of the progress length difference and not different moments of a time expression of a changing progress length difference.

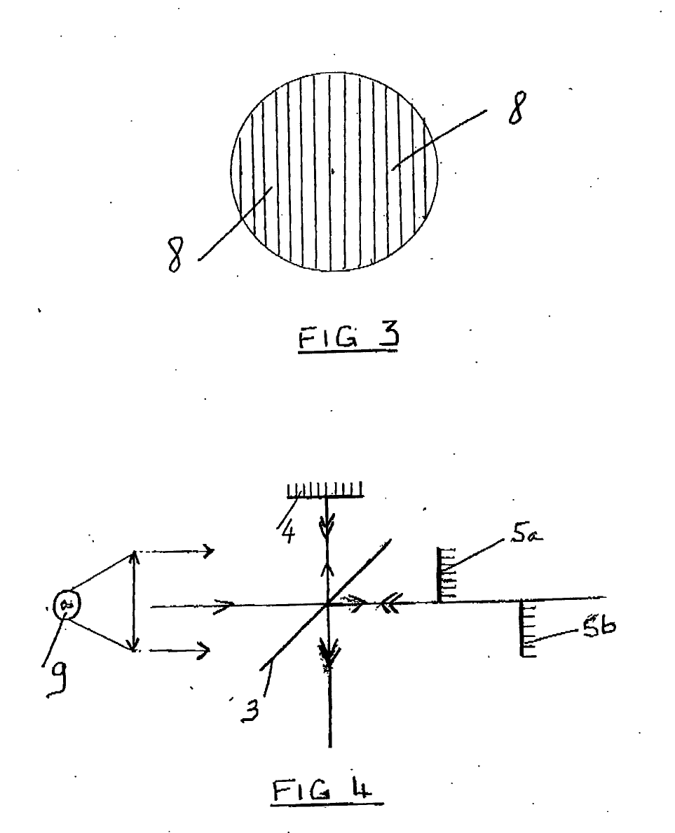

In a non-limiting example of this second embodiment of the invention, the interference fringe patterns 8 are projected onto a charge-coupled device (CCD) camera as shown in FIG. 3, where vertical fringes are shown by way of example.

Each of the fringe images at the wavelengths λᵣ and λᵢ is projected in succession onto a CCD camera and is recorded. Each image is analyzed scan line by scan line merely by phase shifting in space (local evaluation of phase for each group of fringes).

The slope of the straight line of FIG. 2 is determined preferably by the least squares method, preferably scan line by scan line (but the invention is not limited thereto).

An average is then taken for all of the scan lines in the camera.

The general advantages of the invention in the present embodiment consist in performing wavelength measurements:

firstly by eliminating any mechanical action on various optical parts of the equipment while performing measurements.

secondly by using original calculation methods of the algorithmic type for detecting phase that are adapted to information processing; and

thirdly by determining the slope of the straight line φᵢ (φᵣ) by a least squares method based on a very large number of independent measurements.

Such measuring systems or equipment of the invention enable measurements to be performed quasi-automatically without optical parts being moved during measurements, and providing measurement uncertainty that is extremely small.

There is no need to take account of any departure from straightness in the fringes projected onto the CCD sensor. Furthermore, the path length differences accessible to a space interferometer in accordance with the second feature of the invention are much smaller than those which can be obtained with a time interferometer in accordance with the first feature of our invention (approximately 10² fringes instead of approximately 10⁵ fringes).

According to a third feature of the invention, a measurement system is implemented in which the incorporated interferometer makes it possible to obtain a large path length difference.

According to this third feature of our invention, an interferometer is used in which the fringe field is split into two portions.

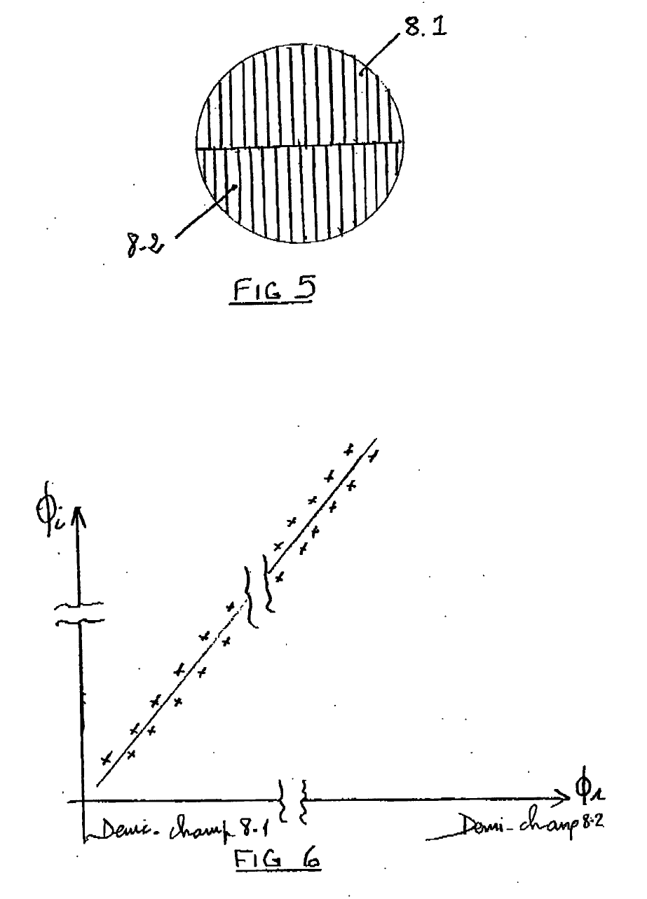

FIG. 4 is a highly simplified diagram of the interferometer implemented in application of the third feature of the invention. The total reflection mirror 5 of FIG. 1 is replaced by two half-mirrors 5a and 5b placed respectively in an upper position and in a lower position relative to the light beams that are diffused successively from sources 9 with energy at the reference wavelength λᵣ and at the unknown wavelength λᵢ to be determined. The two half-mirrors are placed at different distances and the separation between them can easily be discovered within accuracy of 10λ. FIG. 5 shows the resulting image of two interference patterns.

The first of the two half-mirrors 5a corresponds to small path length differences and the second half-mirror 5b corresponds to much greater path length differences, depending on the distance between the two half-mirrors 5a and 5b.

As described with reference to the second embodiment of the invention, the interferometer corresponding to the third embodiment of the invention is illuminated initially by the wavelength λᵣ and subsequently by the unknown, second wavelength λᵢ.

A first evaluation of the ratio λᵣ/λᵢ is made on the basis of the recorded interference patterns, which evaluation suffices to determine the order difference between the fringes of the top portion 8.1 and the bottom portion 8.2 of the interference pattern. A satisfactory “connection” can thus be achieved between the two half-interference patterns, as shown in FIG. 6.

In other words, in this embodiment, a high precision for measurement is realised, thanks to the use of a statistic approach in a multiplicity of points and also by taking profit from measurement in two experimental points areas which are particularly far from each other, the two areas corresponding to a high progress length difference between them, and so the two areas being far from each other on the line to be identified in the plan (Φᵢ, Φᵣ).

The half-field 8.1 has approximately 10² fringes, the half-field 8.2 has approximately 10² fringes as well, but the mean phase difference between the two half-interference patterns corresponds to about 10⁵ fringes. The different and novel lambdameters described in this patent application presents accuracy that has never been equaled since the final uncertainty on the ratio λᵣ/λᵢ is extremely small.

By using a CCD camera of modest quality (an 8-bit camera with 10 pixels), the order of magnitude for the uncertainty on the ratio λᵣ/λᵢ is 2×10⁻⁷.

Using the same camera, this uncertainty can be made as small as 3×10⁻¹¹ by using the two half-field techniques (i.e. two interference patterns).

Unlike most commercially-available lambdameters, this novel type of space lambdameter in accordance with the third feature of our invention does not present any limit on its use apart from the spectral sensitivity of the CCD camera and the spectral characteristics of the transparency of the optical elements involved. The spectrum of wavelengths λ of radiation that can be measured is extremely broad. In particular, any wavelength in the visible part of the spectrum can be measured. Nor is there any limit on the difference between the unknown and the reference wavelengths. Where necessary, a different algorithm can be used for detecting phase at each of the two wavelengths.

Furthermore, the radiation sources used can be used equally well on a continuous basis or on a pulsed basis.

1. An optical device for measuring an optical wavelength including an equipment for providing at least two different optical path lengths, and for guiding on these two path lengths a flow of light having a reference wavelength and also a flow of light having a wavelength to be determined, the device further comprising means for measuring a difference between the phases at the outputs of the two path lengths and that for the reference wavelength and for the wavelength to be determined, the means for measuring the phase being means realising a light interference between two beams at a same wavelength, the device further comprising means for determining a ratio between firstly the phase difference measured for the wavelength to be determined and secondly the phase difference measured for the reference wavelength, characterised in that the device comprises means for transporting the light on a plurality which is higher than two of different path lengths, and also means for measuring the phases at the output for each of this plurality of path lengths and so providing, for each path length, an experimental dot consisting in a couple of measured phases corresponding respectively to the two wavelengths, the device so providing a plurality of such experimental dots and the device further comprising statistical processing means for assessing the slope of a straight line represented by the group constituted by this plurality of experimental dots.

2. An optical device according to the preceding claim, including means for projecting on a plan an interfering light in the form of a series of fringes, and means for measuring the phase of the light at a plurality of different places of this series of fringes, so providing each time the emplacement of an experimental dot of said group of experimental dots.

3. A device according to the preceding claim, characterised in that it includes a camera and means for projecting the series of fringes on a plan picked up by the camera.

4. Optical device according to the preceding claim, characterised in that it includes means for automatic processing of the image picked up by the camera, those processing means providing a phase of the light on the basis of the evolution of the intensity in the fringes over a given localised area of the picked up image.

5. Optical device according to claim 1, characterised in that it includes an optical assembly providing simultaneously two separate paths of light having different path lengths as well as means for realising, for each of these paths, an interference allowing a phase measurement at the output of such paths.

6. Optical device according to claim 5, characterised in that the optical assembly comprising two separate paths includes two differently positioned mirrors, so that the light passing by those two respective mirrors describes paths having two different lengths.

7. Optical device according to claim 6, characterised in that it includes means for using the light reflected by each of the differently positioned mirrors and for illuminating each time, a plan with a series of interference fringes, each series of fringes corresponding respectively to one of the two mirrors and each series so corresponding to whole path length which corresponds to the path length introduced by the corresponding mirror, the device further comprising means for measuring in each series each time a plurality of phases in a plurality of localised places of the considered series, each place corresponding to a path length variation supplementary to the path length introduced by the considered mirror, the device so providing two groups of experimental dots, one group corresponding to the path length introduced by a given mirror, the other group corresponding to the path length introduced by the other mirror.

8. Optical device according to claim 1, characterised in that it includes a moving optical element placed on the path of the light and means for maintaining this mobile optical element in a plurality of positions at the different measurement path lengths.

9. Optical device according to the preceding claim, characterised in that the means for measuring the phase are means for time sampling the intensity of the interference light, adapted for deducing from this sampled intensity a series of successive measurements of the phase according to its time evolution.

10. A method for measuring an optical wavelength including the step of providing two different optical path lengths, and transporting, on those two paths lengths a light having a reference wavelength, as well as a light having a wavelength to be determined, the method further comprising the step of measuring the difference between the phases at the output for the two path lengths and that for the reference wavelength as well as for the wavelength to be measured, the phases being measured by realising a light interference between two beams of the same wavelength, the method further comprising the step of determining a ratio between firstly the difference of phases for the wavelength to be determined and secondly the difference of phases for the reference wavelength, wherein the method includes the step of transporting the light over a plurality higher than two of different path lengths, and the step of measuring the output phases for each of the plurality of path lengths, for each of the two wavelengths, so providing for each path length an experimental dot consisting in a couple of measured phases with the two wavelengths, so providing a group of experimental dots, the method further comprising a statistical processing of said group of dots for assessing the slope of a straight line represented by this group of dots.

11. A method according to the preceding claim further including the step consisting in projecting an interfering light having the form of a series of fringes into a plan, and the step consisting in measuring the phase of the light at a plurality of different places of this series of fringes, so providing each time the emplacement of a said experimental dot.

12. A method according to the preceding claim, characterised in that it includes the step of providing a camera and the step of projecting a series of fringes on a plan which is picked up by the camera.

13. A method according to the preceding claim, characterised in that it includes the step which consists in providing means for automatic processing of the image picked up by the camera, those processing means determining a phase of the light on the basis of the evolution of intensity in the fringes over a given localised area of the picked up image.

14. A method according to claim 10, characterised in that it includes the step of providing simultaneously two separate paths of light having different path lengths and providing, for each of these two paths, a light interference allowing a phase measurement at the output of such paths.

15. Method according to claim 14, characterised in that those two paths are provided on the basis of two mirrors having respective different positions so that the light passing by those two respective mirrors progresses along two different path lengths.

16. Method according to claim 15, characterised in that it is used, for each of the two wavelengths, the light reflected by each of the differently positioned mirrors for illuminating a plan each time by a series of interference fringes, each series corresponding respectively to one of the two mirrors and so corresponding to a respective global path length as introduced by the corresponding mirror, the method further comprising the step which consists in measuring in each of these two series a plurality of phases in a plurality of localised places of the series, each such place corresponding to a path length variation which is supplementary to that globally introduced by the considered mirror, the method so providing two groups of experimental dots, one corresponding to the path length introduced by a mirror, the other corresponding to the path length introduced by the other mirror.

17. Method according to claim 10, characterised in that it includes the step of providing a moving optical element which is placed on the path of the light and means for maintaining this moving optical element in a plurality of positions which correspond to the different measurement path lengths.

18. Method according to the preceding claim, characterised in that it includes the step of using means for measuring the phase which are means for time sampling the intensity of the interference light, adapted for deducing from this sampled intensity a series of successive measurements of the phase during its time evolution.
